(19) United States
(12) Patent Application Publication
(10) Pub. No.: US 2015/0169039 A1
(43) Pub. Date: Jun. 18, 2015

(54) Electronic Apparatus, Method and Storage Medium

(71) Applicant: Kabushiki Kaisha Toshiba, Tokyo (JP)

(72) Inventor: Masao Teshima, Kunitachi-shi (JP)

(73) Assignee: Kabushiki Kaisha Toshiba, Tokyo (JP)

(21) Appl. No.: 14/267,736

(22) Filed: May 1, 2014

Related U.S. Application Data
(60) Provisional application No. 61/916,678, filed on Dec. 16, 2013.

(51) Int. Cl. G06F 1/32; H04W 4/00

(52) U.S. Cl. CPC G06F 1/3287; H04W 4/008

(57) ABSTRACT

According to one embodiment, an electronic apparatus comprises a contactless communication module and a controller. The contactless communication module is configured to execute contactless communication with an external device. The controller is configured to power off the contactless communication module when the contactless communication is not executed within a certain period. The controller is configured to power off the contactless communication module before the certain period elapses when predetermined processing which involves the contactless communication is completed.

### CROSS-REFERENCE TO RELATED APPLICATIONS

This application claims the benefit of U.S. Provisional Application No. 61/916,678, filed Dec. 16, 2013, the entire contents of which are incorporated herein by reference.

### FIELD

Embodiments described herein relate generally to an electronic apparatus, a method, and a storage medium.

### BACKGROUND

In recent years, various kinds of electronic apparatuses such as notebook personal computers (PCs) and tablet computers have been developed.

These electronic apparatuses include an apparatus equipped with a module capable of performing contactless communication, for example, Near Field Communication (NFC) (hereinafter referred to as a contactless communication module). According to such a contactless communication module, by only bringing the electronic apparatus near another apparatus equipped with the contactless communication module (for example, holding the electronic apparatus over another apparatus), communication (contactless communication) is enabled between the electronic apparatus and the external device.

In the electronic apparatus equipped with such a contactless communication module, the contactless communication module is constantly performing a polling operation for contactless communication. Thus, even in a case where contactless communication does not need to be performed, energy is consumed by the contactless communication module, which causes the uptime of the electronic apparatus to be reduced.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment;

FIG. 2 is an exemplary diagram showing a system structure of a computer 10;

FIG. 3 is an exemplary block diagram showing mainly a function structure of the computer 10;

FIG. 4 is a flowchart showing an example of steps of processing at login in the present embodiment;

FIG. 5 is an illustration for use in describing an outline of processing at login in the present embodiment;

FIG. 6 is a flowchart showing an example of steps of processing in normal operation in the present embodiment; and

FIG. 7 is an illustration for use in describing an outline of processing in normal operation in the present embodiment.

### DETAILED DESCRIPTION

Various embodiments will be described hereinafter with reference to the accompanying drawings.

In general, according to one embodiment, an electronic apparatus includes a contactless communication module and a controller. The contactless communication module is configured to execute contactless communication with an external device. The controller is configured to power off the contactless communication module when the contactless communication is not executed within a certain period. The controller is configured to power off the contactless communication module before the certain period elapses when predetermined processing which involves the contactless communication is completed.

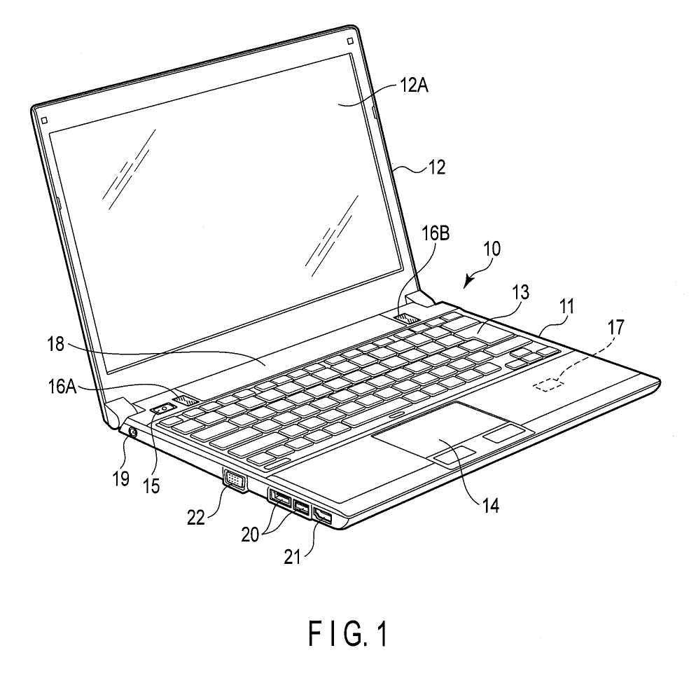

Firstly, with reference to FIG. 1, a structure of the electronic apparatus according to the embodiment will be described. FIG. 1 is a perspective view showing an appearance of the electronic apparatus according to the embodiment. The electronic apparatus can be realized variously as a notebook personal computer, a tablet computer, or the like. Here, it is assumed that the electronic apparatus is realized as a notebook personal computer (PC) 10, for example.

As shown in FIG. 1, the computer 10 includes a computer main body (electronic apparatus main body) 11 and a display unit 12. A display, such as a liquid crystal display (LCD) 12A, is incorporated in the display unit 12.

The display unit 12 is attached to the computer main body 11 such that it is rotatably movable between an open position at which an upper surface of the computer main body 11 is exposed (that is, the display surface of the display unit 12 is exposed) and a closed position at which the upper surface of the computer main body 11 is covered by the display unit 12. The computer main body 11 includes a thin box-shaped housing, and on the top of the computer main body 11, a keyboard 13, a touchpad (touch input module) 14, a power switch 15 for powering on/off the main computer 10, speakers 16A and 16B, and a contactless communication module 17 for contactless communication are arranged.

The contactless communication module 17 is arranged on the right side of the touchpad 14, for example. The contactless communication module 17 is used for executing contactless communication with a contactless communication device (external device) near the contactless communication module 17. Contactless communication includes Near Field Communication (NFC), for example. Note that the apparatus may be structured such that only an antenna for establishing electrical connection with the contactless communication module 17 is arranged at the upper surface of the computer main body 11.

Although explanations will be given below assuming the case where the contactless communication device (external device) is mainly an NFC-enabled card type device (hereinafter referred to as an NFC card), it may be other electronic devices capable of executing contactless communication such as NFC.

The computer 10 is configured to receive power from a battery 18. The battery 18 is mounted removably at a rear end portion of the computer main body 11, for example. Note that a battery 18 may be one which is built in the computer 10.

In addition, the computer main body 11 is provided with a power connector (DC power input terminal) 19. The power connector 19 is provided on a side, for example, the left side, of the computer main body 11. An external power supply is detachably connected to the power connector 19. An AC adapter can be used as the external power supply. The AC adapter is a power unit for converting commercial power (AC power) into DC power.

The computer 10 is driven by power supplied from the battery 18 or power supplied from the external power supply. When the external power supply is not connected to the power connector 19 of the computer 10, the computer 10 is driven by the power supplied from the battery 18. Meanwhile, when the external power supply is connected to the power connector 19 of the computer 10, the computer 10 is driven by the power supplied from the external power supply. Further, the power supplied from the external power supply is also used for charging the battery 18.

Further, the computer main body 11 is provided with several USB ports 20, a High-definition Multimedia Interface (HDMI) (registered trademark) output terminal 21, and an RGB port 22.

Logging into the computer 10 is enabled by using the above-mentioned NFC card. That is, if the NFC card is placed in proximity with (held over) the contactless communication module 17, login processing is executed in the computer 10. When the login processing is completed, a user is enabled to use the computer 10.

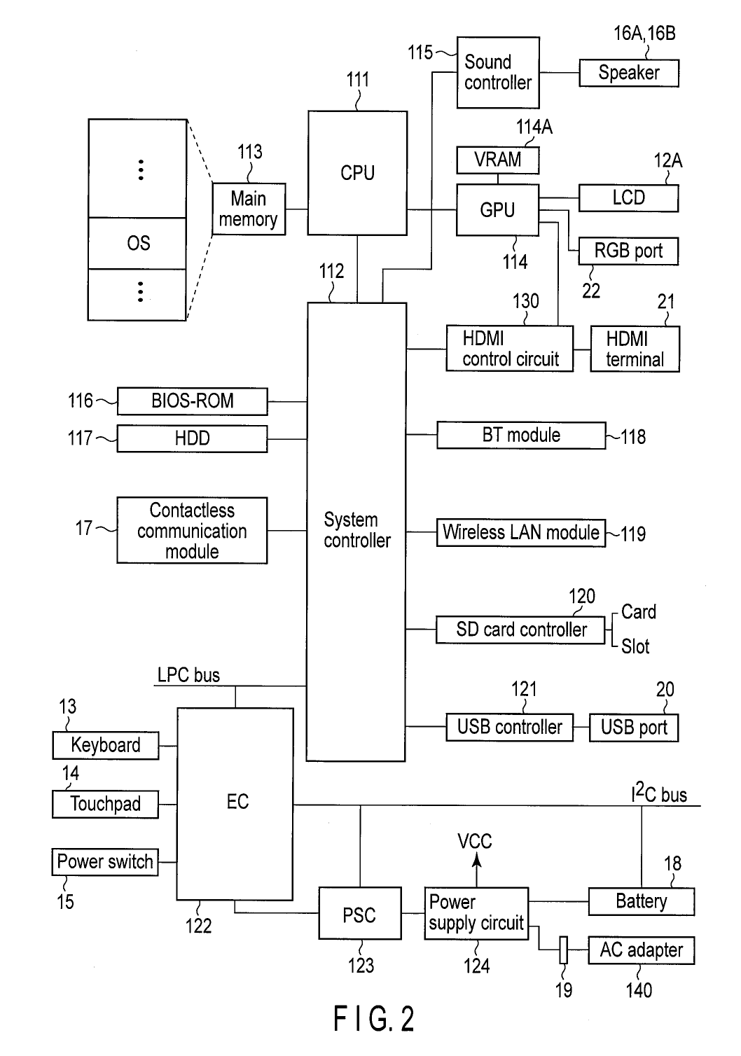

FIG. 2 shows a system structure of the computer 10. The computer 10 includes a CPU 111, a system controller 112, a main memory 113, a graphics processing unit (GPU) 114, a sound controller 115, a BIOS-ROM 116, a hard disk drive (HDD) 117, a Bluetooth (registered trademark)(BT) module 118, a wireless LAN module 119, a card controller 120, a USB controller 121, an embedded controller IC (EC) 122, a power supply controller (PSC) 123, a power supply circuit 124, etc.

The CPU 111 is a processor which controls the operation of each component of the computer 10. The CPU 111 executes various kinds of software loaded into the main memory 113 from the HDD 117. The software includes an operating system (OS), etc.

In addition, the CPU 111 executes a Basic Input Output System (BIOS) stored in the BIOS-ROM 116, which is a nonvolatile memory. The BIOS is a system program for hardware control.

The system controller 112 is a bridge device for connecting between the CPU 111 and each component. A serial ATA controller for controlling the HDD 117 is built in the system controller 112. Further, the system controller 112 executes communication with each device on a Low PIN Count (LPC) bus.

The GPU 114 is a display controller for controlling the LCD 12A to be used as a display monitor of the computer 10. The GPU 114 generates a display signal (LVDS signal) to be supplied to the LCD 12A from display data stored in a video memory (VRAM) 114A.

The GPU 114 can also generate an HDMI video signal and an analog RGB signal from the display data. The HDMI output terminal 21 can send the HDMI video signal (uncompresed digital image signal) and a digital audio signal to an external display by means of a cable. Further, the analog RGB signal is supplied to the external display via the RGB port 22.

An HDMI control circuit 130 shown in FIG. 2 is an interface for sending the HDMI video signal and the digital audio signal to the external display via the HDMI output terminal 21.

The sound controller 115 is a sound source device, and outputs audio data to be reproduced to the speakers 16A and 16B.

The BT module 118 is a module configured to execute wireless communication with a Bluetooth-enabled device by using the Bluetooth.

The wireless LAN module 119 is a module configured to execute wireless communication conforming to the IEEE 802.11 standard, for example.

The card controller 120 executes writing of data in a memory card inserted in a card slot provided in the computer main body 11 and reading of data from the memory card.

The USB controller 121 executes communication with an external device connected via the USB port 20.

The EC 122 is connected to the LPC bus. In addition, the EC 122 is interconnected with the power supply controller (PSC) 123 and the battery 18 via a serial bus such as an I²C bus.

The EC 122 is a power management controller for executing power management of the computer 10, and is realized as a one-chip microcomputer with a built-in keyboard controller, for example, for controlling the keyboard (KB) 13, the touchpad 14, etc. The EC 122 has the function of powering on and off the computer 10 in response to an operation of the power switch 15 by a user. The control to power on and off the computer 10 is executed by a cooperative operation between the EC 122 and the PSC 123. When the PSC 123 receives an ON signal transmitted from the EC 122, the PSC 123 controls the power supply circuit 124 to turn on power of (i.e., power on) the computer 10. Further, when the PSC 123 receives an OFF signal transmitted from the EC 122, the PSC 123 controls the power supply circuit 124 to turn off power of (i.e., power off) the computer 10.

The EC 122, the PSC 123, and the power supply circuit 124 can be operated by the power supplied from the battery 18 or an AC adapter 140 even during a period in which the computer 10 is powered off.

The power supply circuit 124 uses the power supplied from the battery 18, or the power supplied from the AC adapter 140 connected to the computer main body 11 as the external power supply to generate power (operation power supply) which should be supplied to each component.

The contactless communication module (NFC module) 17 is a module (contactless communication IC) configured to execute contactless communication with the NFC card brought near the contactless communication module 17 as described above, and is connected to the system controller 112, for example, as shown in FIG. 2. Further, the contactless communication module 17 can be operated by the power supplied from the battery 18 or the AC adapter 140, for example, even during a period in which the computer 10 is powered off.

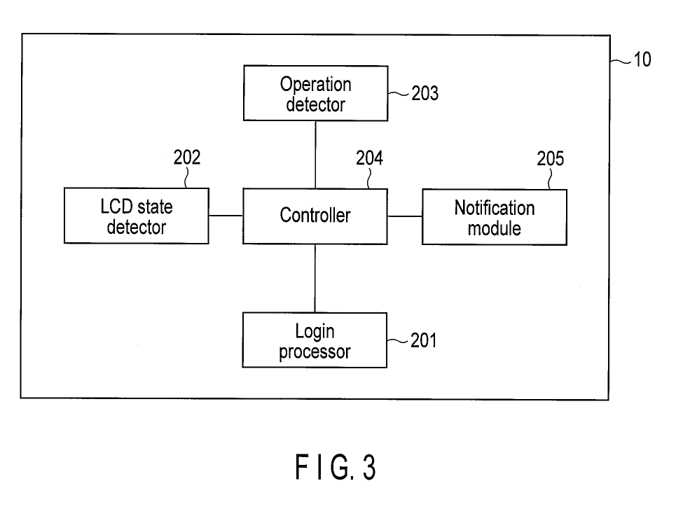

FIG. 3 is a block showing mainly a function structure of the computer 10. As shown in FIG. 3, the computer 10 includes a login processor 201, an LCD state detector 202, an operation detector 203, a controller 204, and a notification module 205. In the present embodiment, each of these modules 201 to 205 is realized when the CPU 111 executes the operating system or the BIOS, for example.

Here, if logging into the computer 10 is enabled by using the NFC card as mentioned above, the NFC card stores login information. The login information is information for enabling the computer 10 to be used, and includes, for example, a user ID assigned to a user who uses the computer 10 and a password set by the user.

In the above case, when the NFC card is brought near the contactless communication module 17, the contactless communication module 17 receives the login information from the NFC card by executing contactless communication with the NFC card. The login information received by the contactless communication module 17 is transferred to the login processor 201.

The login processor 201 executes the login processing for allowing the user to use the computer 10 based on the login information received by the contactless communication module 17.

The LCD state detector 202 detects the state of (the LCD 12A incorporated in) the display unit 12 provided for the computer 10. Specifically, the LCD state detector 202 detects that the upper surface of the computer main body 11 is exposed (that is, the display unit 12 has been moved from the closed position to the open position).

In the case of the notebook personal computer 10 as shown in FIG. 1, the state in which the upper surface of the computer main body 11 is exposed refers to the state in which the display unit 12 (LCD 12A) is opened. Meanwhile, the state in which the upper surface of the computer main body 11 is not exposed refers to the state in which the display unit 12 (LCD 12A) is closed.

The operation detector 203 detects a predetermined operation on the computer 10 by a user. Note that the user's predetermined operation is defined in the computer 10 in advance.

The controller 204 is a module configured to switch between the ON state and the OFF state of power of the contactless communication module 17 provided in the computer 10. When the contactless communication module 17 is powered on, the contactless communication module 17 can perform contactless communication with the external device such as the NFC card. Conversely, when the contactless communication module 17 is powered off, the contactless communication module 17 cannot perform contactless communication with the external device such as the NFC card.

If the contactless communication module 17 is powered on, for example, the controller 204 switches the state of the power of the contactless communication module 17 from the ON state to the OFF state when the contactless communication is not performed within a certain period.

Also, if the contactless communication module 17 is powered on, for example, the controller 204 switches the state of the power of the contactless communication module 17 from the ON state to the OFF state before the certain period elapses when the login processing in the login processor 201 (i.e., predetermined processing which involves contactless communication) is completed.

Meanwhile, if the contactless communication module 17 is powered off, for example, the controller 204 switches the state of the power of the contactless communication module 17 from the OFF state to the ON state when it has been detected by the LCD state detector 202 that the upper surface of the computer main body 11 is exposed (that is, the display unit 12 is opened in the computer 10).

Also, if the contactless communication module 17 is powered off, for example, the controller 204 switches the state of the power of the contactless communication module 17 from the OFF state to the ON state when the operation detector 203 has detected a predetermined operation by the user.

The notification module 205 notifies the user who uses the computer 10 of the state of the power (the ON state or OFF state) of the contactless communication module 17 switched by the controller 204 described above. In this case, the state of the power of the contactless communication module 17 may be notified by lighting or extinguishing an LED provided on the computer 10, for example, or (information indicating) the state may be displayed on the computer 10.

The operation of the electronic apparatus (computer 10) according to the present embodiment will now be described. Here, the processing when a user logs into the computer 10 to use it (hereinafter referred to as processing at login) and the processing when the user is using the computer 10 after completion of the login (hereinafter referred to as processing in normal operation) will be described.

In the computer 10, a period (certain period) for switching the state of the power of the aforementioned contactless communication module 17 from the ON state to the OFF state is set in advance. This period can be changed by the user, for example, as appropriate.

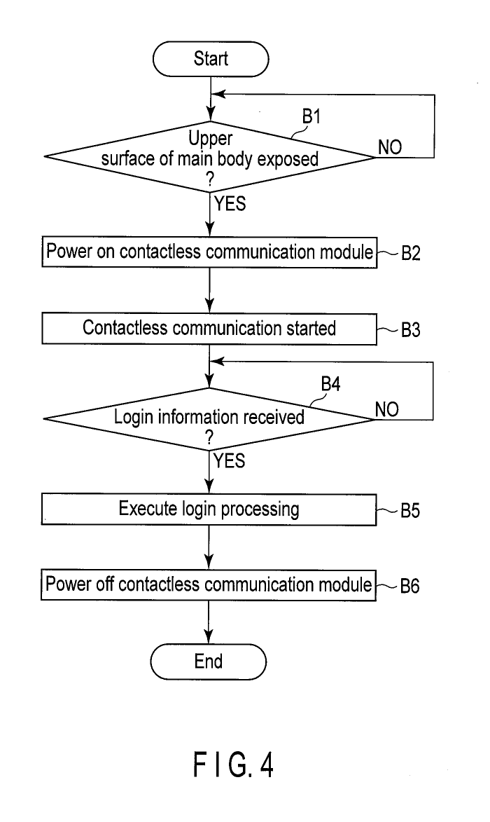

Firstly, with reference to the flowchart of FIG. 4, steps of processing at login in the present embodiment will be described.

In the present embodiment, as described above, logging into the computer 10 with an NFC card owned by the user, for example, is enabled. More specifically, login information (for example, a user ID, password, etc.) is stored in the NFC card, and by bringing the NFC card near (the contactless communication module 17 provided in) the computer 10, the login processing is executed by using the login information. In this way, the user can easily use the computer 10 without manually inputting the login information, for example.

In addition, it is assumed here that the computer 10 itself is powered on, but the contactless communication module 17 is powered off. Further, it is assumed that (the LCD 12A incorporated in) the display unit 12 provided for the computer 10 is in the closed position.

Here, the LCD state detector 202 can detect exposure of the upper surface of the computer main body 11 as described above.

Thereby, the LCD state detector 202 determines whether the upper surface of the computer main body 11 is exposed by rotative movement of the display unit 12 (block B1).

If it is determined that the upper surface of the computer main body 11 is not exposed (NO in block B1), the processing of block B1 is repeated.

Meanwhile, if it is determined that the upper surface of the computer main body 11 is exposed (YES in block B1), the controller 204 powers on the contactless communication module 17 (block B2). When the contactless communication module 17 is powered on, the notification module 205 notifies the user of the state of the contactless communication module 17 powered on.

In this way, the contactless communication module 17 starts contactless communication (NFC) (block B3). In this case, the contactless communication module 17 starts a polling operation for searching for an external device (for example, an NFC card) which can perform contactless communication.

Here, when the contactless communication module 17 and the NFC card are close to each other, the contactless communication module 17 can receive the login information stored in the NFC card.

The login processor 201 determines whether the contactless communication module 17 has received the login information (block 34).

If it is determined that the contactless communication module 17 has not received the login information (NO in block B4), the above-mentioned polling operation is continued, and the processing of block B4 is repeated.

Meanwhile, if it is determined that the contactless communication module 17 has received the login information (YES in block B4), the login processor 201 executes the login processing based on the login information (block B5). With such login processing, user authentication is performed based on the user ID and the password included in the login information, and the user is allowed to login if the user authentication is successful (that is, if the user ID and the password are those registered in the computer 10 in advance).

If the login processing is completed in block B5 (for example, if the login by the user is permitted), the controller 204 powers off the contactless communication module 17 before the period set in advance as described above elapses (block B6). More specifically, the contactless communication module 17 is powered off immediately after the completion of the login processing, for example. Thereby, the contactless communication (polling operation) in the contactless communication module 17 is terminated (stopped). Note that when the contactless communication module 17 is powered off, the notification module 205 notifies the user of the state of the contactless communication module 17 powered off.

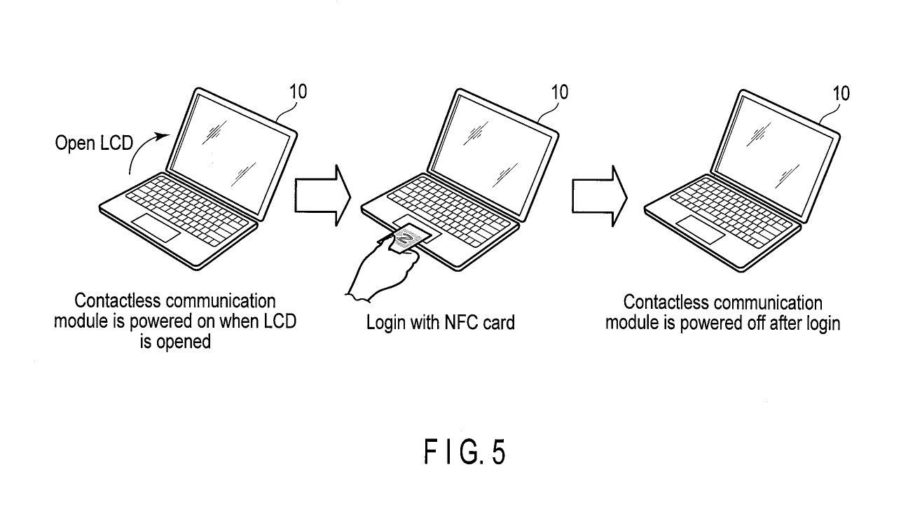

That is, according to the processing at login in the above embodiment, it is possible to have the contactless communication module 17 powered on automatically when the display unit 12 (LCD 12A) is opened for a user to log into the computer 10, and have the contactless communication module 17 powered off automatically when the login is completed with the use of the NFC card, for example, as shown in FIG. 5.

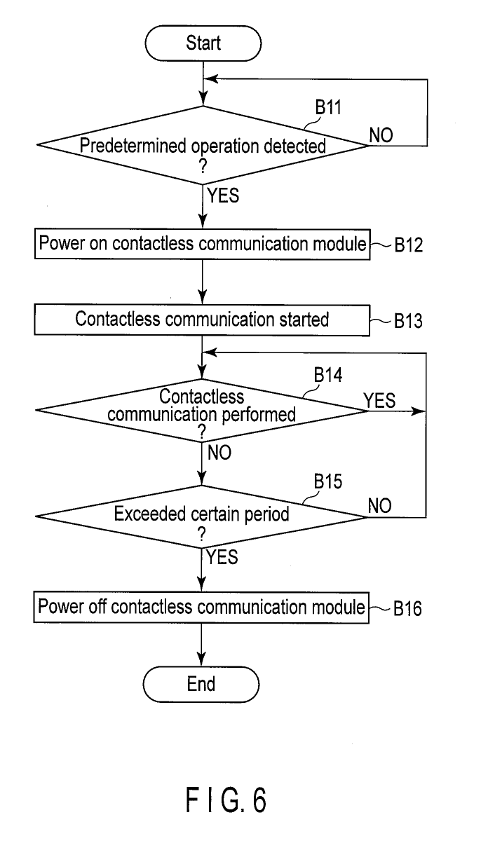

Next, with reference to the flowchart of FIG. 6, steps of processing in normal operation in the present embodiment will be described. Here, the computer 10 is in a state in which the processing at login described above has been executed. That is, the user has completed logging into the computer 10, and the contactless communication module 17 is powered off.

Here, the operation detector 203 can detect a predetermined operation on the computer 10 by the user as described above.

Thereby, the operation detector 203 determines whether the user's predetermined operation on the computer 10 has been detected (block B11).

It should be noted that the user's predetermined operation in the present embodiment is intended as the operation determined in advance for powering on contactless communication (for example, NFC). The operation includes, for example, an operation of pressing a predetermined button provided on the computer 10, an operation on the touchpad (touch input module) 14, an operation for launching an application (a program) which uses contactless communication, and the like. The operation on the touchpad 14 includes an operation of touching a predetermined place (area) on the touchpad 14 for a certain period, an operation of drawing a predetermined figure (for example, a circle) on the touchpad 14, and the like.

If it is determined that the user's predetermined operation has not been detected (NO in block B11), the processing of block B11 is repeated.

Meanwhile, if it is determined that the user's predetermined operation has been detected (YES in block B11), the controller 204 powers on the contactless communication module 17 (block B12). When the contactless communication module 17 is powered on, the notification module 205 notifies the user of the state of the contactless communication module 17 powered on.

In this way, contactless communication (NFC) is started in the contactless communication module 17 (block B13). In this case, the contactless communication module 17 starts the aforementioned polling operation.

After the polling operation has been started, when the contactless communication module 17 and a contactless communication-enabled external device (for example, an NFC card) are brought close to each other, it becomes possible to execute contactless communication between the contactless communication module 17 and the external device.

Here, by monitoring the contactless communication module 17, for example, the controller 204 determines whether contactless communication is being performed between the contactless communication module 17 and the external device (block B14).

If it is determined that contactless communication is being performed (YES in block B14), the monitoring of the contactless communication module 17 is continued, and the processing of block B14 is repeated.

Meanwhile, if it is determined that contactless communication is not being performed (NO in block B14), the controller 204 determines whether the period for which the contactless communication has not been performed exceeds a certain period (preset period) (block B15).

If it is determined that the period has not exceeded the certain period (NO in block B15), the processing is repeated by returning to block B14.

Meanwhile, if it is determined that the period has exceeded the certain period (YES in block B15), the controller 204 powers off the contactless communication module 17 (block B16). In this way, the contactless communication (polling operation) in the contactless communication module 17 is terminated (stopped). Note that when the contactless communication module 17 is powered off, the notification module 205 notifies the user of the state of the contactless communication module 17 powered off.

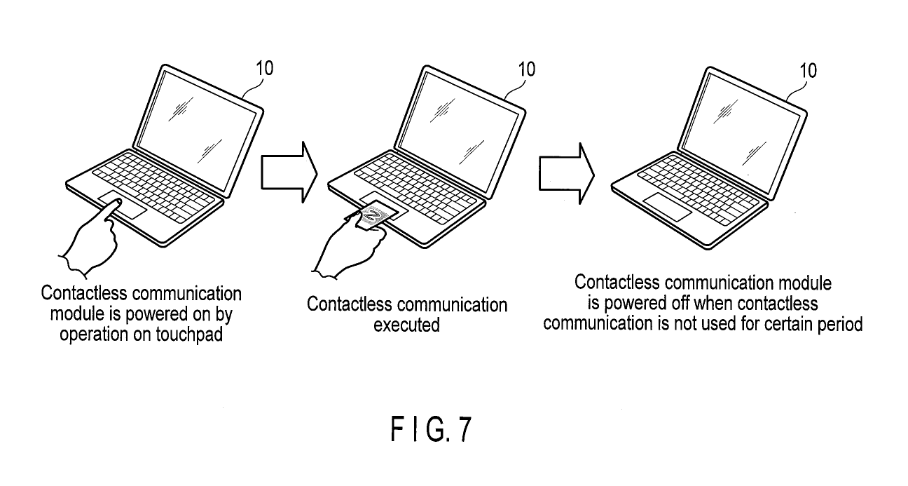

That is, according to the processing in normal operation in the present embodiment described above, as shown in FIG. 7, it is possible to have the contactless communication module 17 powered on if a predetermined operation on the computer 10 (such as an operation on the touchpad 14) is performed, for example, and have the contactless communication module 17 powered off automatically if (the operation for) contactless communication is not performed within a certain period after execution of contactless communication. It should be noted that if contactless communication is to be executed again after the contactless communication module 17 has been powered off as described above, the contactless communication module 17 can be powered on by performing the predetermined operation on the computer 10.

As described above, in the present embodiment, the contactless communication module 17 is powered off if contactless communication is not executed within a certain period, and the contactless communication module 17 is powered off before the certain period elapses (immediately after completion of the login processing, for example) if predetermined processing which involves contactless communication (the login processing, for example) is completed.

Here, because the communication speed of contactless communication such as the NFC is slow, such communication is mainly used for exchanging low-traffic data. If high-traffic data communication is to be performed, other communication techniques (for example, WLAN and Bluetooth) are often used.

Accordingly, contactless communication is performed only for predetermined processing, such as the login processing, and there are not so many occasions where contactless communication is utilized.

That is, if contactless communication is set to be executable only when necessary, the user will not be inconvenienced even if the contactless communication module 17 is powered off in other instances.

Therefore, in the present embodiment, by the above structure, it is possible to power off the contactless communication module 17 when contactless communication does not need to be performed. Because of this feature, it is possible to avoid energy consumption due to a polling operation for contactless communication during this time, and realize energy saving of an electronic apparatus equipped with the contactless communication module 17, such as the computer 10.

In addition, in the present embodiment, in a case where the contactless communication module 17 is powered off, when the upper surface of the computer main body 11 is exposed by rotative movement of the (LCD 12A incorporated in the) display unit 12 (that is, when the display unit 12 is opened), the contactless communication module 17 is powered on. In this way, in the present embodiment, login is allowed by using the NFC card, for example, without requiring the user to perform a particular operation for powering on the contactless communication module 17.

Further, in the present embodiment, in a case where the contactless communication module 17 is powered off, when a predetermined user's operation (the operation for powering on the contactless communication module 17) is detected, the contactless communication module 17 is powered on. In this way, in the present embodiment, even if contactless communication module 17 is powered off, the contactless communication is enabled with only a simple operation by the user. Accordingly, energy saving can be realized without inconveniencing the user.

In the case of using the touchpad 14 for powering on the contactless communication module 17, the operation on the touchpad 14 for powering on the contactless communication module 17 may be that in which a predetermined place (area) on the touchpad 14 is touched for a certain period, or a predetermined figure (for example, a circle) is drawn on the touchpad 14. In this way, the operation on the touchpad 14 for powering on the contactless communication module 17 can be distinguished from the other normal operations to the touchpad. By virtue of this feature, it is possible to prevent the contactless communication module 17 from being powered on despite the user's intentions, and reduce wasteful energy consumption.

Also, in the present embodiment, the fact that the contactless communication module 17 is powered on or powered off is notified. By such notification, in the present embodiment, a user can easily grasp whether the contactless communication is available or not in the computer 10.

In referring to FIG. 4 above, it has been described that the polling operation is continued if it is determined that the login information has not been received from the contactless communication module 17. However, even in this case, the contactless communication module 17 is powered off automatically after a lapse of a certain period, thereby enabling further energy saving.

Further, it has been described that the structure described above enables the realization of energy saving in the present embodiment. However, if energy saving is unnecessary as in the case where the computer 10 is driven by the power supplied from the AC adapter 140 connected as the external power supply, for example, a configuration such that the power-on/power-off state of the contactless communication module 17 is not automatically switched may be adopted. That is, with such a configuration, the contactless communication module 17 is always powered on if the computer 10 is driven by the power supplied from the AC adapter 140, and the power-on/power-off state of the contactless communication module 17 is automatically switched only if the computer 10 is driven by the power supplied from the battery 18.

Further, in a case where the computer 10 is driven by the power supplied from the battery 18, when the residual capacity of the battery 18 is reduced, the certain period in block B15 shown in FIG. 6 can be shortened. With such a configuration, it becomes possible to further attempt to save energy because the contactless communication module 17 can be powered off at a shorter period when the residual capacity of the battery 18 is reduced.

While the electronic apparatus according to the present embodiment has mainly been described as a notebook computer 10, the present embodiment may be applied to other electronic apparatuses equipped with the contactless communication module 17 such as a tablet computer or a smartphone.

Further, in the present embodiment, the login processing has mainly been described as an example of processing for powering off the contactless communication module 17 before a certain period elapses. However, such processing is not limited to the login processing and may be another kind of processing, etc., related to start-up of the electronic apparatus. More specifically, in the case of an electronic apparatus having the function of enabling the electronic apparatus to be powered on by using the NFC card, for example, the electronic apparatus can be structured in such a way that the contactless communication module 17 is powered off after the electronic apparatus has been powered on. In addition, the processing for powering off the contactless communication module 17 before a certain period elapses may be any type of processing as long as it temporarily uses contactless communication but is not likely to use contactless communication thereafter, such as the processing of making the settings of a communication counterpart external device by using contactless communication at the time of starting data communication other than contactless communication, for example.

Since all the steps of the processing of the electronic apparatus according to the present embodiment can be implemented by software, an advantage similar to that of the present embodiment can easily be realized by installing a computer program which executes the steps of this processing on an ordinary computer via a computer-readable storage medium having stored thereon such a program, and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a contactless communication module configured to execute contactless communication with an external device; and
a controller configured to power off the contactless communication module when the contactless communication is not executed within a certain period, wherein
the controller is configured to power off the contactless communication module before the certain period elapses when predetermined processing which involves the contactless communication is completed.

2. The electronic apparatus of claim 1, wherein the predetermined processing comprises processing related to start-up of the electronic apparatus.

3. The electronic apparatus of claim 2, wherein the processing related to start-up of the electronic apparatus comprises login processing for enabling the electronic apparatus to be used.

4. The electronic apparatus of claim 1, further comprising:
an electronic apparatus main body comprising the contactless communication module; and
a display unit arranged in such a way that the display unit is rotatably movable between a position at which an upper surface of the electronic apparatus main body is exposed and a position at which the upper surface of the electronic apparatus main body is covered, wherein
if the contactless communication module is powered off, the controller is configured to power on the contactless communication module when the upper surface of the electronic apparatus main body is exposed by rotative movement of the display unit.

5. The electronic apparatus of claim 1, further comprising an operation detector configured to detect a predetermined user's operation, wherein
if the contactless communication module is powered off, the controller is configured to power on the contactless communication module when the predetermined user's operation is detected.

6. The electronic apparatus of claim 1, further comprising a notification module configured to notify that the contactless communication module is powered on or powered off.

7. The electronic apparatus of claim 1, further comprising a battery which supplies power to the electronic apparatus, wherein
the controller is configured to power off the contactless communication module when the electronic apparatus is driven by the power supplied from the battery.

8. A method comprising:
powering off a contactless communication module configured to execute contactless communication with an external device when the contactless communication is not executed within a certain period; and
powering off the contactless communication module before the certain period elapses when predetermined processing which involves the contactless communication is completed.

9. A non-transitory computer-readable storage medium having stored thereon a computer program which is executable by a computer, the computer program comprising instructions capable of causing the computer to execute functions of:
powering off a contactless communication module configured to execute contactless communication with an external device when the contactless communication is not executed within a certain period; and
powering off the contactless communication module before the certain period elapses when predetermined processing which involves the contactless communication is completed.
